(19) United States
(12) Patent Application Publication
(10) Pub. No.: US 2005/0082855 A1
(43) Pub. Date: Apr. 21, 2005

(54) Chopsticks fix - a holding and manipulation aid

(76) Inventor: Brent Alan Baxter, Castro Valley, CA (US)

Correspondence Address: BRENT ALAN BAXTER, 5209 SEAVIEW AVE., CASTRO VALLEY, CA, 94546, US

(21) Appl. No.: 10/903,735

(22) Filed: Jul. 31, 2004

Related U.S. Application Data
(60) Provisional application No. 60/491,943, filed on Aug. 1, 2003.

(51) Int. Cl. B26B 1/00; A47G 21/10

(52) U.S. Cl. 294/99.2; 30/125

(57) ABSTRACT

A chopsticks holding and positioning aid that effectively both assists the user in holding the chopsticks and also stabilizes these sticks into proper orientation, preventing them from crossing over and even creating an effective gentle spring return action but does not interfere with the natural holding techniques of the user. These chopsticks holders 10 are created with simplicity of design. They are extremely low cost to produce can even be made out of environmentally friendly and recyclable materials, are intended to be disposable. These chopsticks holders 10 are fabricated from single pieces of flexible materials having with no joints, springs nor moving parts. Also, my chopstick aid will fit chopsticks of virtually any dimension and width including disposable wooden chopsticks and thick heavy fine restaurant standards. In addition, when used in stacked combination these chopsticks holders 10 can provide progressive levels or resistance that can be matched with the users ability level or can be used as components in the teaching of chopsticks usage. Furthermore, these tools are esthetically pleasing and visually complementary to chopsticks and can easily be printed serving a secondary function as print sources for Diners to read or be entertained.

### RELATED APPLICATIONS

| | | |
|---|---|---|
| U.S. Pat. No. 4,576,408 | Maneki | Mar. 18, 1986 |
| U.S. Pat. No. 4,659,128 | Dong | Apr. 21, 1987 |
| U.S. Pat. No. 5056809 | Laramie | Jun. 2, 1987 |
| U.S. Pat. No. 4,826,227 | Lew | May 2, 1989 |
| U.S. Pat. No. 5,911,462 | Hui | Jun. 15, 1999 |
| U.S. Pat. No. 6,402,214 | Weiner | Jun. 11, 2002 |
| U.S. Pat. No. 6,454,328 | Barillos | Sep. 24, 2002 |
| U.S. Pat. No. D463,220 | Yun | Sep. 24, 2002 |
| U.S. Pat. No. D474,653 | Stewart | May 20, 2003 |
| U.S. Pat. No. 6,581,997 | Martikainen , et al. | Jun. 24, 2003 |

### FIELD OF THE INVENTION

The present invention relates to chopstick eating appliances and, more specifically, to a novel holder and progressive teaching aid for chopsticks.

### BACKGROUND OF THE INVENTION

Chopsticks eating appliances are a well-known paired oriental style eating utensils in which a user simultaneously holds and manipulates two identical sticks for the purpose grabbing and eating food. Anyone familiar with Chopsticks knows that to use them requires a high level of skill and experience adeptness that only comes from practice.

Some common recognized problems for chopsticks use includes the challenge of properly balancing and grasping dual utensils in one hand while simultaneously attempting to grab, hold onto, or otherwise maneuver pieces of food. What usually happens, especially with initial use, is that the sticks will frequently slip out of proper alignment during the act of grabbing food causing food to be ejected (usually with admirable velocity) from between the two sticks. During chopsticks the hand and digits are manipulating the sticks in many coordinated directional planes at once to grasp food. Many, especially young children, the elderly or those with limited manual dexterity, find using chopsticks highly difficult. They may want to use chopsticks, but may become frustrated over the challenge or they may feel uncomfortable or embarrassed over their limited skills. For many being able to use some chopsticks holding aid would be very desirable that is altogether easy to use, effective and of a subtle design profile, being very inexpensive to manufacture would also be beneficial and be disposable and could even be made of environmentally friendly materials. Still, the reality of chopsticks usage is that there are probably as many slight variations in technique employed by users as there are different hand sizes and dexterity levels. This results in a need for creating a device that can work for most users.

Many patents have been developed in an attempt to solve the chopsticks challenge. These include designs creating tweezers like mechanisms, or those that employ springs, mechanical parts and resilient materials. Most of these designs require either a new type of chopstick manufacture or an attachment that limits chopsticks orientation and movement to a single plane such as one sees in tweezers. Additionally, Most apparatuses are complex, clunky, unattractive or are costly to manufacture, a fact that may exacerbate some users existing negative feelings associated with having to use a chopsticks assist device which is the visible equivalent of “training wheels.”

Chopsticks holding apparatus generally only provide unilateral planar motion (open and close) which is counter to the omni directional manipulation typical of the varied chopstick use and technique. Having an apparatus that both provide support to hold would be highly advantageous and allow for motion in many directions that also does not interfere with the user's natural grasp, comfort and technique.

There is a need for a training tool that allows for progressive skill levels and does NOT interfere with users' hand size, natural grasp comfort and developing technique. This is because the user must be able to adjust and refine his/her technique while learning especially in areas of grasping and chopsticks alignment about the digits. This is especially the case with small children learning to eat with chopsticks utensils.

A few stand out devices, which successfully deal with most above concerns. These include U.S. Pat. No. 6,402,214 by Weiner teaches an appliance for holding chopsticks comprising a paper or plastic sipping straw-like tubes with a flexible center formed by a bellows or a thinned web section. This device does not satisfy the objective of full range of motion of the sticks since the chopsticks cannot be separated or narrowed beyond the dimensions of the bellowed straw piece. Furthermore, the fastening method of using the stretched slits in the tubular straw is a comparatively insecure fastening method that only weakly holds chopsticks and is of limited range. This results because the farther the slits are separated, the weaker the frictional hold available. Thus, in reality there is very limited adjustability to meet varying chopsticks dimensions resulting in limited use. U.S. Pat. No. 4,826,227 by Lew teaches an inexpensive chopstick device comprising a pair of sticks mechanically coupled to one another by an open-loop spring secured to disposable chopsticks. This device requires the manufacture of a new type of disposable chopsticks and is not able to attach onto any existing chopstick. Additionally, the range of motion is limited to the size and length of the wire manufactured. Furthermore, a thin wire provides limited planar torsion stability. U.S. Pat. No. 4,576,408 by Maneki teaches a chopstick holder comprising a unitary interrupted circular ring of resilient material having a pair of slots or openings cut to fit the insertion of chopsticks. However, this device is limited to a particular type of chopsticks, particularly the conventional bamboo or wood restaurant type disposable chopsticks that are split into two sticks at the time of use by the user. Relatedly, its device must have particular sets of chopstick dimensions milled accordingly. New fabrications are needed to fit other chopsticks dimensions making this invention is limited in its use. In addition, while this device may be manufactured inexpensively by any standards, the eventual purchase cost may still be more than restaurant owners may want to pay for such items. Furthermore, this device cannot provide progressive levels of support that would be very helpful during teaching which would be very advantageous when used as a teaching tool of chopsticks usage.

It is clear from the above that while concerns such as controlling the skewing movement and allowing for the necessary lateral movement of the chopsticks are adequately addressed. Further issues such as full range of motion, adapting to various user hand sizes and differing use techniques, and the ability of a single device able to fit a large variety chopstick dimension and thicknesses are not addressed. In addition, a device that can provide progressive levels of chopsticks control is not addressed. Further still, devices have not been conceived which do not require some custom manufacture by which the final cost to the consumer (such as restaurants) would require a negligible investment risk; this would make its purchase even more attractive.

It is therefore a primary object of the present invention to provide an extremely inexpensive chopsticks holding device that is cheap enough to be thrown away after a single use and be of so low cost as to be enticing for consumer purchase.

Another Primary object is to provide a coupling mechanism that can be used with a variety of chopsticks dimensions including the disposable restaurant split type-chopsticks, the heavier and the non-disposable kinds of chopsticks.

Further, another prime objective is for a chopsticks holder that can and similarly can automatically adapt itself to varying hand sizes and chopsticks angle usage and techniques.

Another major object of the present invention is to provide a method and aid in the teaching of chopsticks usage especially for young children and for the unskilled user especially who has difficulty holding and manipulating chopsticks. This can be accomplished using a very simple and novel progressive method for allowing the user to be able to increase or decrease the stabilization effect.

Another object is to provide a coupling mechanism that can be stacked or manufactured at varying thicknesses to provide variable levels of stabilizing control to fit user preferences or audience.

Yet another object is to provide a coupling device for chopsticks that has a good utility and aids in controlling such sticks, but does not interfere with or override natural holding techniques of the user.

Still another principal object of the present invention is to provide a coupling mechanism adapted to work with any angular movement between the chopsticks including but not limited to lateral, vertical, pivotal and a rotational moment along any plane.

A further object of the present invention is to provide a spring-based coupling device for chopsticks which both maintain the chopsticks gently but securely against the user's digits and is also able to closely follow the varied movements of these same digits of the hand. Thus, this will improve the gripping of the chopsticks while all but eliminating the possibility of such sticks becoming disengaged while in use.

Yet another object of the present invention is to provide an aesthetically pleasing coupling device design that complements the chopsticks.

Yet another object of the present invention is to provide a relatively non-obvious device one that is highly undetectable which is not distracting or has the visual appearance of a “crutch.”

Yet another object of the present invention is to provide a holding device for chopsticks on which can easily be printed. Which can also double as print source and can be used in advertising campaigns or with some teemed text such as fortunes or interesting oriental facts and the like (since pieces can be printed on flat).

### BRIEF STATEMENT OF THE INVENTION

This device is a chopstick holder that effectively both assists the user in holding the chopsticks and also stabilizes these sticks into proper orientation during use and preventing them from crossing over and even creating an effective gentle spring return action. But these chopsticks holders 10 do not interfere with the natural holding techniques of the user. These chopsticks holders 10 are created with such simplicity of design. They are extremely low cost to produce can even be made out of environmentally friendly and recyclable materials, are intended to be disposable and would be a valuable addition to oriental restaurants and the like to be offered alongside chopsticks. These chopsticks aids are fabricated from single pieces of treated heavy paper stock or from some thin plastic materials or similar flexible substances and with no joints, springs nor moving parts. Also, my chopstick holder will fit chopsticks of virtually any dimension and width including disposable wooden chopsticks and thick heavy fine restaurant standards. In addition, when used in stacked combination these chopsticks holders 10 can provide progressive levels or resistance that can be matched with the users ability level or can be used as components in the teaching of chopsticks usage. Furthermore, these tools are esthetically pleasing and visually complementary to chopsticks and can easily be printed serving a secondary function as print sources for Diners to read or be entertained or can serve as an advertising vehicle for companies doing business.

The unit itself comprises a strip of pliable material exhibiting enough flexibility to allow chopsticks inserted through endpoints in the strip to be looped completely around some 360 degrees, creating an open-ended circle from the looped strip. On opposite sides of the strip are located a pair of cut slits of a modest diameter roughly the width of a typical chopstick tip. The narrower tips of the chopsticks are pushed through the slits in the back side the strip and are slid all the way until reaching a point some thumb's width from the end. Then, both chopsticks are looped around approximately 360 degrees from the initial insertion. This looping around completely backwards creates tension on the flexible strip to return to its normal flat state thereby creating a novel and effective method for producing a return “spring” which gently secures the chopsticks to the users hand with proper use alignment.

### LIST OF REFERENCE NUMERALS

10 chopsticks holding and manipulation aid
20 oriental chopsticks utensils
30 cut slits in 10 for insertion of chopsticks
31 center point of crossed slits cut in 10
33 small diameter hole at center point
32 extruding lips of 10 that are pushed outward when chopsticks are inserted
40 morsel of food
50 text image that can be printed on 10

### BRIEF DESCRIPTION OF THE DRAWINGS

This invention may be more clearly understood from the following detailed description and by reference to the drawing in which:

FIG. 1 is a perspective view of the diner using the chopstick holder of this invention;

FIG. 2A is a side view of the holder of this invention sans insertion of any chopsticks;

FIG. 2B is top plan view of the holder of this invention sans insertion of any chopsticks;

FIG. 3 is a perspective view of the holder of this invention with initial insertion of chopsticks;

FIG. 4 is a perspective view of the holder of this invention with completed insertion of chopsticks;

FIG. 5A is a perspective view showing the rotation of chopsticks at 45 degrees;

FIG. 5B is a perspective view showing the rotation of chopsticks at 90 degrees;

FIG. 5C is a perspective view showing the rotation of chopsticks at 135 degrees;

FIG. 5D is a perspective view showing the rotation of chopsticks at 360 degrees, one complete revolution;

FIG. 6A is top plan view of an end portion of the holder of this invention detailing a primary slit variation for the insertion of chopsticks;

FIG. 6B is top plan view of an end portion of the holder of this invention detailing an alternate slit variation for the insertion of chopsticks;

FIG. 6C is top plan view of an end portion of the holder of this invention detailing an alternate slit variation for the insertion of chopsticks;

FIGS. 7A-7C shows perspective views these same end pieces (shown in FIG. 6) of the holder of this invention demonstrating how the pieces of strip material are stretched out securely to hold chopsticks in place; and

FIG. 8 is a top plan view of this invention showing the available space for an advertising or text message, here a product logo.

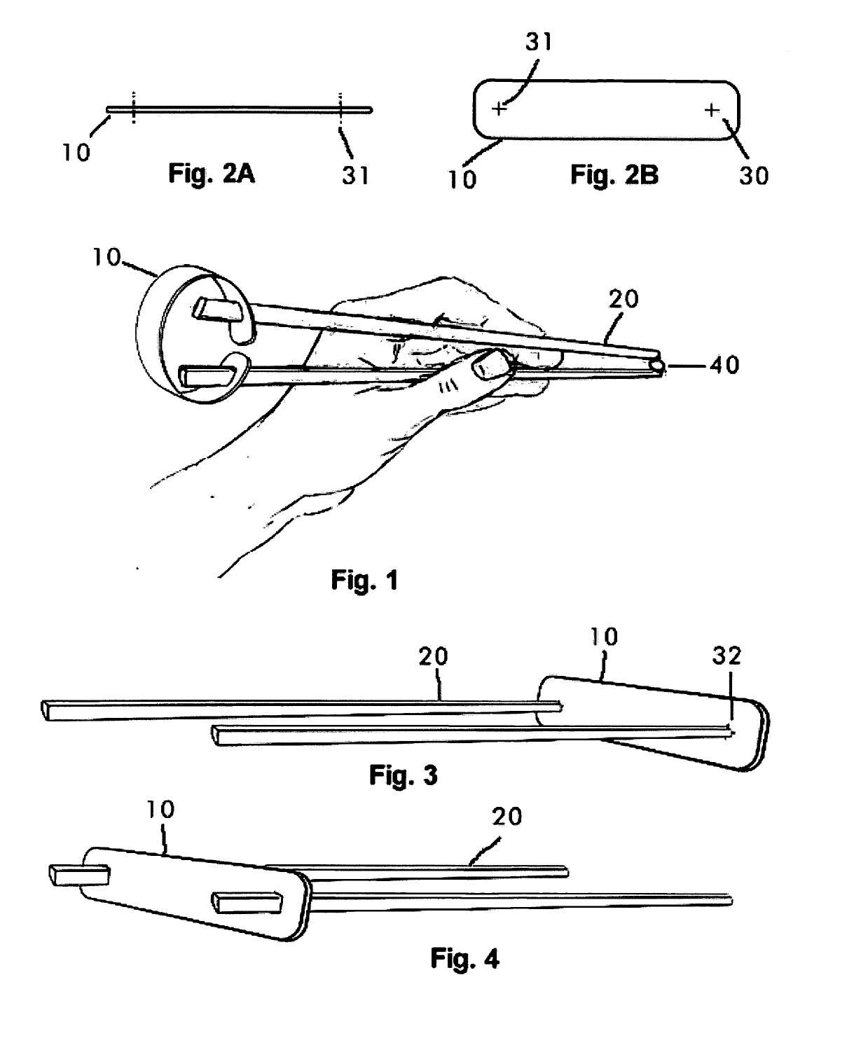

### DETAILED DESCRIPTION OF THE DRAWINGS

One of the biggest aspects of this invention is its simplicity of design while simultaneously being able to accomplish so many benefits to the user, not the least of which is movement flexibility. This chopsticks holding aid has the flexibility follow most any movement of the hand during the action os using chopsticks 20. This is accomplished through the novel approach of pulling a flexible strip 10 completely around. Once the strip 10 is pulled out of its normal flat state, its tensile strength will cause it to want to normal. This return pressure gently but effectively pushes the chopsticks 20 back against the palm and finger digits of the hand as the energy of the flexed strip material 10 arcs backward causing the inserted chopsticks utensils to go along with it. Since the digits and the hand form a barrier to being able to return, the chopsticks 20 are effectively secured against whatever is blocking the flexed strip's return spring path. So effective is this securing action, that the user can even completely relax their hold on the chopsticks 20 and the chopsticks will not leave their position in the hand. This is highly advantageous for learning chopstick users who must necessarily adjust their hand grip frequently when learning proper technique.

One of the greatest difficulties for learners of chopsticks technique is simultaneously to hold, adjust and try to grab food; frequently, just the act of adjusting the chopsticks in hand causes many to lose control. However, when securely fastened against the hand and digits in the manner of this invention lost of chopsticks control is not a concern. In a like manner, the chopsticks are so secure that they naturally follow most any hand movement and movement of the fingers because the chopsticks are so well attached to the hand. To say that the chopsticks are “glued to the hand without adhesives” is not an exaggeration. They function and follow the exact user hand and digit movement so well they might as well be magnetized to the hand. Additionally, since the strip 10 is flexed in a circular 360 degree arc, accordingly the strip 10 tends to want to follow a circular path. The advantageous result is that an operative/functional spring is created which tends to separates the chopsticks after pressure on the chopsticks is relaxed following some food pinching or grabbing activity. Additionally, the width and natural solidity of the strip 10 tends to inhibit torsion or flipping of the chopsticks that commonly occurs in use and often results in the dropping of food morsels 40.

The chopsticks 20 stay in the hand so well one actually has to make an effort to dislodge them because the virtual adhesive effect is so solid. However, were one to manage to release one of the pair of sticks (usually the upper stick away from the thumb, the only effect is that the stick would swing smoothly around and hang securely in its insertion slot).

Regarding FIG. 1 in the manner of the design of this invention, the chopsticks aid 10 is attached to conventional chopsticks 20 and allow the user more control and stabilization while holding and manipulating chopsticks 20; this in turn allows the user to have more confidence in their ability and does not interfere with the user's natural hand movements. In addition, it can be seen that the chopsticks aid 10 is smooth in design producing a clean non distracting lines that compliment the chopsticks. Even so, this design can be made of flexible transparent material even further decreasing its noticeability.

FIGS. 3 and 4 show how the chopsticks are inserted into the chopsticks aid 10. Chopsticks are inserted individually, or together into the precut slots 32, or the center point of crossed slits 31 cut in 10 as indicated in FIG. 3. It will be noticed that the chopsticks aid 10 will be found at the front end of the chopsticks 20 and as the strips are pushed through the openings (or the strip is pulled back along the chopsticks). One will also notice that the diameter of the front end of the chopsticks is narrower than the rear end as is typical of chopsticks 20. This basic chopsticks design is exploited in the securing design of this invention. As explained more fully with respect to FIG. 7, as the diameter of the chopsticks 20 increase while being inserted into the aid strip 10 this causes the opening created by the slits 32 to expand and stretch with the material pushing back to its original flat orientation resulting in a snug tight fit that securely holds the chopsticks inside the aid 10.

Regarding how far to push in the chopsticks 20 into the sheet aid 10, an exact distance is not necessary and would be more up to the user. Other than not pushing the chopsticks to the very edge or they will slip through, there is a large range to work with and would depend more on the length of the strip than anything else. The recommended distance from the end of the chopstick to retain adequate positioning would be some ¾ of an inch.

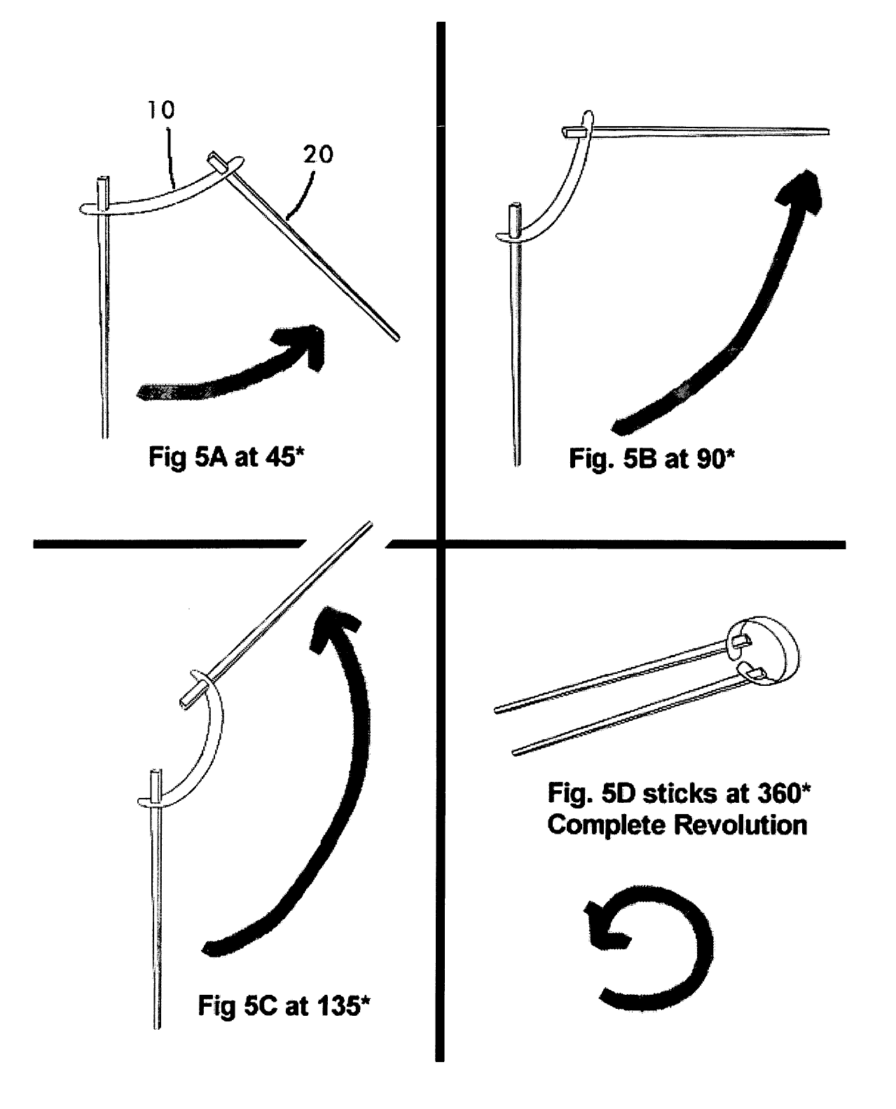

FIGS. 5A through 5D show the complete rotation of the inserted chopsticks necessary for functioning of this invention.

In order to achieve the unique qualities of this device, the chopsticks 20 attached to holder 10 need to be pulled back around a full complete turn, or 360 degrees. A turning around of the strip creates a dynamic flex tension in the material of the strip aid 10 where the tensile strength of the material attempts to flex back creating a novel approach to creating a return spring. Such a return spring tendency has a number of benefits below which will be outlined. It should also be noted that if one wants to view the text or advertisement on a particular side of the strip during use, then the user should insert the chopsticks 20 through the strip 10 where the text is facing the opposite side because the chopsticks 20 will be pulled completely around. Also text or designs may be placed on either side, or both sides of the strip 10, without affecting the functioning of the device.

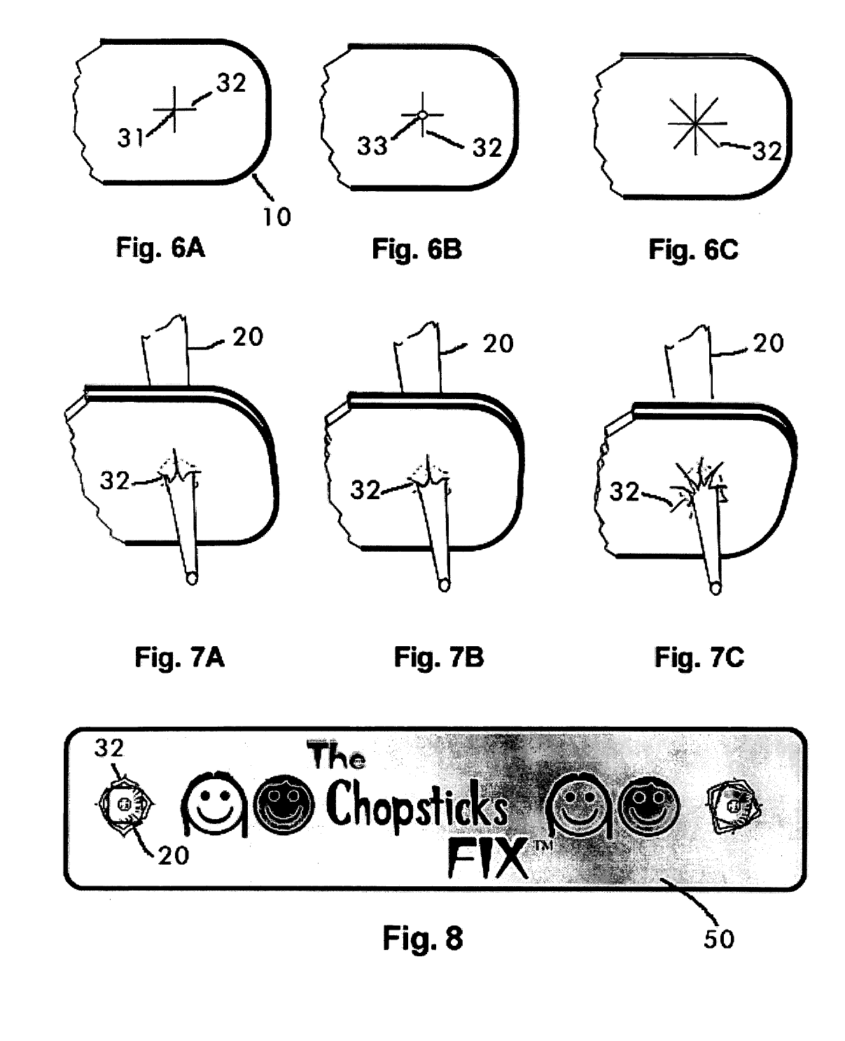

FIGS. 6A through 6C show various slit patterning which would accomplish the fastening of the chopsticks to the flexible strip aid 10. As can be seen in FIG. 6A, an entrance hole for the chopsticks can be accomplished by cutting slits in a “plus” or equivalent cutting pattern. While a single slit (not shown) may accomplish the same thing, a crosscut will allow a hole to be pushed in which better matches the diameter of the inserted chopsticks. A hole is accomplished as the ends of the slits 30 leaf out while the chopsticks are being pushed out. The ends of the slits 30 push out and form what resembles mini triangles which encircle the shaft of the chopsticks 20 and aid in securely holding them in place.

When inserted through the slits 30 of the strip 10, the chopsticks are held quite effectively in a manner which stays secure for quite some time. With the disposable type of strip 10, generally of treated paper card stock, the fastening will remain secure for well longer than the duration of a meal, after which, the strip 10 will be discarded. For more permanent materials such as certain types of flexible plastics, the strip can be manufactured using a combination of attributes which would best meat a balance between permanence and useful flexibility.

Regarding the secure fastening of the chopsticks by stretching the material of the strip aid 10, as can be seen in FIGS. 7A through 7C, one key element of this invention regarding the securing of chopsticks is its ability to fasten many different sizes of chopsticks with a singly manufactured strip 10 securely. Secure fastening is accomplished through a manner of stressing and stretching the opening in the strip 10 created when chopsticks are inserted through the slits 30 created in the strip. Although many configurations will work, only a few will be discussed for illustration. As can be seen in FIGS. 7A through 7C when the chopsticks are inserted through the slits 30 they push out on the material. The slits are created to be slightly smaller than typical chopsticks diameters which are usually around ¼th of an inch. Thus, the slits will be cut some 3/16ths of an inch. The chopsticks 20 are then initially easily and comfortably inserted in the strip 10, where the chopstick diameter will cause the strips to separate creating an opening for the chopsticks. While they can easily be inserted the rest of the way (even by very young children) the diameter soon meets a point where a minimum effort is required causing the material to stretch and flex a small amount as the diameter of the chopsticks increases. Such material stretching serves to lock and pin the chopsticks inside the strip openings created by pushed out cut slits 30. In the disposable card stock strips 10 effective fastening lasts for hours even during heavy use. With more solid materials used, of course, the chopsticks gripping effect will last much longer, depending upon the material used it will never wear out. If preferred, the diameter of the cut slits 30 can also be cut to match the precise diameters of chopsticks. The pushed out triangle forms by themselves will also sufficiently hold chopsticks also in the manner of this invention and would be advantageous if materials were used which have good flexibility but not much sheer strength such as in some plastics. The above is offered for illustrational purposes and any number of variations can result while still remaining within the parameters of this invention. Those skilled in the paper, plastics and flexible material arts will easily be able to make use of appropriate materials and variations without departing from the spirit of this invention.

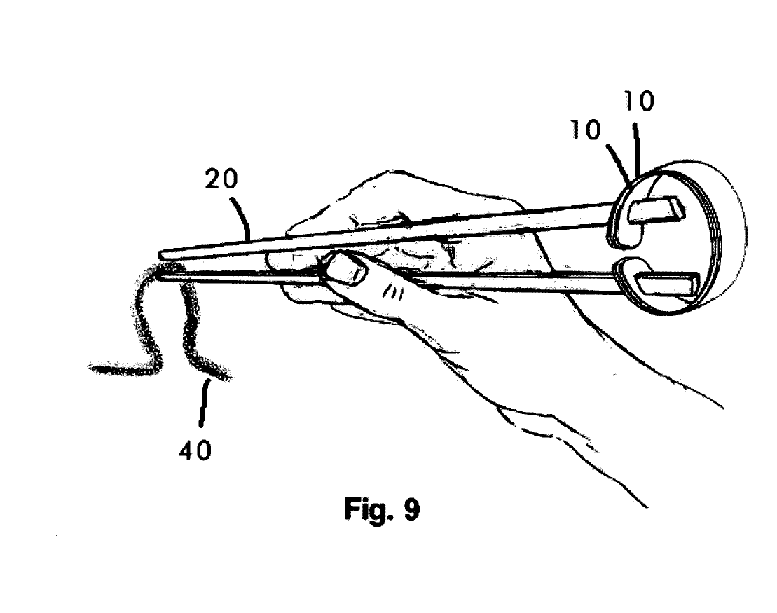

FIG. 8 shows an image of the invention as seen from the front while chopsticks are during being inserted through the slits 30. It can be seen that the narrower front of the chopsticks 20 are followed by an increasingly wider diameter which results in pushing out of portions 32 created by slits 30 in the material of the aid 10. Chopsticks 20 do not have to be oriented along the same axis of any slits 30. It does not matter, because the pushed out portions 32 will grip and surround the shaft of the chopsticks despite their orientation. The only recommendation, especially with weaker paper stock holders 10, would be to avoid excessive rotating of the chopsticks within the pushed out openings of the strip aid 10 because excessive rotating will weaken the grip holding the chopsticks in place. Even if one were to do this, the result would be that the chopsticks would be loosely held in and could slip out when the strip returns to a flat state, such as when not in hand. However, during use, the spring tension exerted during use will keep the chopsticks 20 in place even with loosened holes. Additionally FIG. 8 shows a representative sample of where the strip can be printed on here with a logo and brand name. It can be seen that the print area is virtually the entire strip surface.

Furthermore, both front and back can be printed on with slogans, text and images of any kind. I envision such print use where restaurant owners will find many opportunities to use these mini “posters.” In oriental restaurants theme texts, such as Confucius sayings, the “Special of the Week”,” interesting oriental related facts, anecdotal stories, educational, entertainment and humor, images—anything could be printed. The above would also be very useful in company advertisements where businesses could leave chopsticks holders 10 10 instead of business cards.

Materials for the strips 10 can vary. For the disposable kind, varying thickness of card stock can be used. While thicknesses of paper stock will depend upon the level of resistive return spring needed (thinner for more advanced/capable users, thicker for less skilled users); suggested paper weights, to provide an effective “spring”, are for paper to be in the 100 to 110 lb. range. Laminating the card stock is an effective way of increasing the stock's flexibility ration. Likewise, stock can be waxed and receive similar benefits. Corrugated of paper (cardboard) can be used provided the direction of corrugated material runs parallel with the width of the strips 10. Paper stock provides the most environmentally friendly version of this invention and is preferred for the disposable, restaurant kind. Plastics and even rubbers are also very usable.

The amount of return spring or pressure resulting from the backward wound strip 10 is constant and effective, but also gentle and can be progressively adjusted by two methods. One method is to use thicker or thinner materials of the same manufacture. A second method is to stack layers of the chopstick strip aid 10. Generally the same thickness material could be stacked to increase the comparative return pull. However, mixed thickness or types of materials would also work.

Progressive levels of spring, or resistance to flexing can be achieved by either adjusting the thickness of the materials used, or by stacking holders of the same thickness. As can be seen in FIG. 9, materials can be stacked together to provide increased resistance. It does not matter whether the strips are stacked beforehand, or slid on one at a time, the effect is the same—and increase in resistive force. Additionally, increased resistance can be accomplished by manufacturing sets of strip 10 that have different thicknesses. For example, thick strips could be for beginners, mid thick strips would be for intermediate users and thin strips would be for advanced users who need little assistance. Relatedly, using either method to create progressive resistance would allow users to use the same type of strip 10 to tailor to their skill level. As the user progresses in skill, he or she switches to a thinner version of the strip 10 until the user can go it alone sans any mechanical aid. One of the best things about these current chopsticks holder is the flexibility of the strips to match, move for move, any manipulation of the hand. Almost like Peter Pan's shadow, with the holding mechanism of this invention, chopsticks follow the users hand movements without allowing the chopsticks 20 to be dislodged. It does Such a in the manner described above and has the extraordinary benefit of allowing users to have the confidence and to vary their technique as they learn. Such flexibility is a never before seen advantage with chopsticks holders 10 (most of which are severely limited in their movement range). Even the best of the prior art, can add only a limited range of motion. My invention is virtually unlimited in range while offering secure comfortable chopsticks natural adhesion to the hand.

1. A chopstick holder consisting of a unitary interrupted generally rectangular uniform planar strip of resilient material;
said interrupted planar strip having a pair of ends defining a slit there between;
said interrupted planar strip further defining a pair of elongated pushed out portions of the slots in the wall thereof;
said pushed out portions of the slots having a tensile return tendency to return to its original configuration and having a length sufficient to confine one chopstick in each of said pushed out portions by frictional engagement of the sides of the chopstick with the sides of said pushed out portions after lateral insertion of chopsticks in said slots;
said slits positioned whereby a pair of chopsticks secured in respective slots are angled towards each other but with the ends out of contact and having sufficient spacing therebetween to allow the user to place a morsel of food therebetween;
said holder being compressible by the user sufficiently to allow the morsel to be picked up without the ends of the gap closing; and
said interrupted planar strip providing tensile return tendencies sufficient create a serviceable stability and return spring after user squeezes chopsticks, a return tendency strong enough to assist the chopsticks in maintaining proper orientation while being flexible and constant enough to follow the natural joint movement of the digits of the hand without significant interference which would interfere with chopsticks use or learning.
